(19) United States
(12) Patent Application Publication
(10) Pub. No.: US 2018/0193881 A1
(43) Pub. Date: Jul. 12, 2018

(54) SCREENING PANEL

(71) Applicant: SCHENCK PROCESS AUSTRALIA PTY LTD., North Ryde (AU)

(72) Inventors: Mark Graham LAMPLUGH, Gisborne (AU); Leon Mason HUTTON, Keilor East (AU); Bruce ARMITAGE, Queensland (AU)

(73) Assignee: SCHENCK PROCESS AUSTRALIA PTY LTD., North Ryde (AU)

(21) Appl. No.: 15/915,785

(22) Filed: Mar. 8, 2018

Related U.S. Application Data
(63) Continuation of application No. PCT/AU2016/000315, filed on Sep. 8, 2016.

(30) Foreign Application Priority Data
Sep. 8, 2015 (AU) 2015903654

(51) Int. Cl. B07B 1/46

(52) U.S. Cl. CPC B07B 1/4672; B07B 1/4618

(57) ABSTRACT

A mining screening panel which has a screening surface having spaced stainless steel profiled wires supported on transversely extending spaced rods or bars in which the cross sectional shape of the profiled wires is a vertical truncated diamond. The top portion is an inverted wedge with a flat top with depending diverging sides and the bottom portion is a wedge with dependent converging sides with a flat or convex bottom. The widest portion of the vertical diamond constitutes the notional screening surface and defines the size of the screening aperture. The raised top above the notional screening surface provides the wire a wear surface above the aperture and this provides the wedge wire and aperture with a longer wear life, thus reducing change out periods and reduction in premature failure of wedge wire, which in turn reduces operating costs.

This nonprovisional application is a continuation of International Application No. PCT/AU2016/000315, which was filed on Sep. 8, 2016, and which claims priority to Australian Patent Application No. 2015903654, which was filed in Australia on Sep. 8, 2015, and which are both herein incorporated by reference.

### BACKGROUND OF THE INVENTION

### Field of the Invention

The present invention relates to improvements in ore screening panels used in the separation and grading of materials in the mining and quarrying industries.

### Description of the Background Art

Australian patent 482212 proposed a modular screening panel system for ore screening decks which is now widely used by the mining industry. The screening panels were all of the same size, e.g. 300 mm, and made of reinforced polyurethane. The panels are adapted to be secured to an underlying support frame using dependent spigots which are a force fit into corresponding apertures in the support frame. Australian Patent 517319 provided an alternative method of securing the panels to the frame using a pin expanded fastening concept.

Australian patent 724980 discloses a polyurethane panel with a screening surface defined by spaced apart screening ribs mounted on transversely extending support ribs and additional surface protection ribs extending above the screening surface.

Stainless steel wedge wire has been proposed for use in ore screening panels. Due to the wedge shape of the wire, wedge wire is an effective method of filtering because of the non-clogging capabilities. To improve the wear capabilities the wire is usually treated by hard chroming. Hard chroming is expensive and is only up to 125 micron thick and due to how it is applied, can be uneven, resulting in higher wear areas, which reduce a panels life.

### SUMMARY OF THE INVENTION

It is therefore an object of this invention to increase available open area of the screening panel. It is another object of this invention to improve the wear resistance of the screening surface.

It is therefore an object of the present invention to provide in an exemplary embodiment, a mining screening panel which has a screening surface having spaced stainless steel profiled wires supported on transversely extending spaced rods or bars in which the cross sectional shape of the profiled wires is a vertical truncated diamond.

The top portion is an inverted wedge with a flat top with depending diverging sides and the bottom portion is a wedge with dependent converging sides with a flat or convex bottom. The widest portion of the vertical diamond constitutes the notional screening surface and defines the size of the screening aperture.

One of the most common problems for mining operators is the wearing of screening panels. Any extension of the duration between shutting plants to change out worn panels is of great productivity benefit.

The raised top above the notional screening surface provides the wire a wear surface above the aperture and this provides the wedge wire and aperture with a longer wear life, thus reducing change out periods and reduction in premature failure of wedge wire, which in turn reduces operating costs. Currently, wedge wire suppliers are using hard chroming to address this problem. By changing the profile of the wire, the wear life is increased, because it will wear evenly and give a greater wear surface than the 125 micron hard chrome coating and will be more cost effective.

The use of the wedge wire profiles of this invention also increase the available open area of the screen which also improves the productivity of the screening process.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 depicts a conventional wedge wire screening panel;

FIG. 2 depicts a conventional wedge wire profile; and

FIG. 3 depicts a number of cross sectional wire profiles in accordance with an embodiment of the invention.

### DETAILED DESCRIPTION

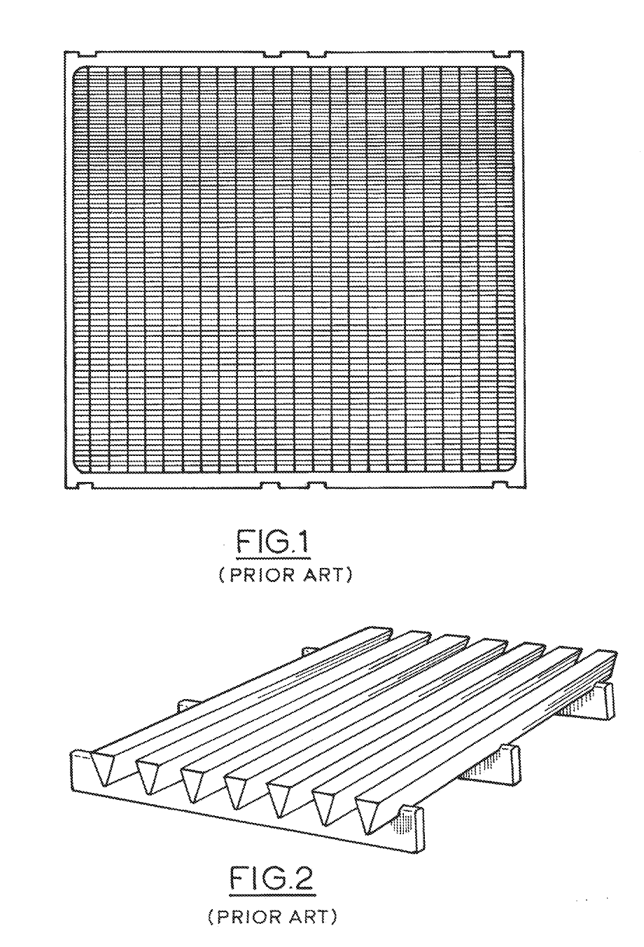

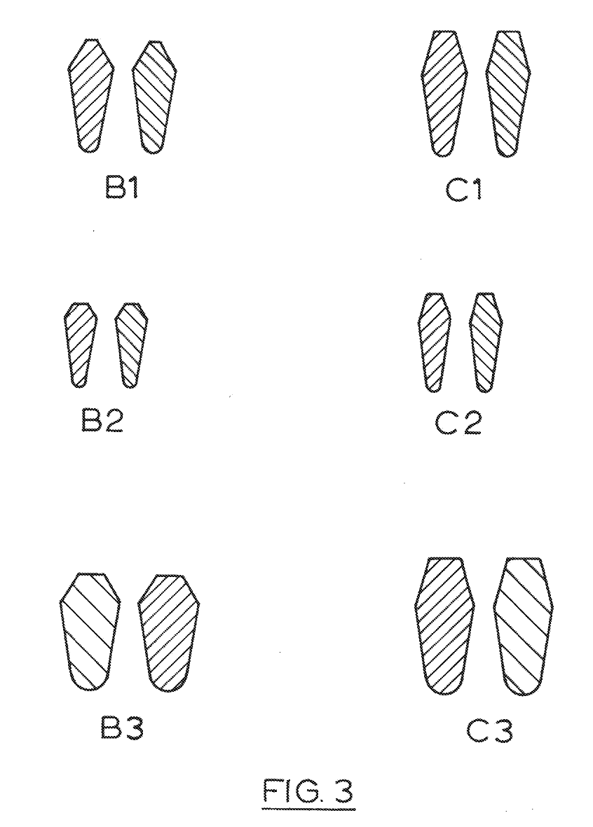

As shown in FIGS. 1 and 2 the conventional wedge wire panel comprises a screening surface of stainless steel flat topped wedges welded to underlying support bars. The screening apertures are defined by the space between the upper edges of the flat topped wedges. The screening panels are enclosed about the periphery of the screening surface in a polyurethane frame that incorporates the desired fixing system.

The improvement of this invention is to provide a truncated diamond wire profile and examples of these are shown in FIG. 3.

To manufacture the panels, the first step is to form the wire cross sectional profile. The stainless steel wire is usually round and wound onto a drum and to form the desired cross section is cold drawn (Pulled) through a die which is generally formed in the surface of two mating wheels with the shape or profile machined into their circumferential surfaces.

The formed wire is then rewound onto another drum on the other side of the machine. This formed wire is then fed to a welding station where it is resistance welded onto the support bars usually rod or bar depending on the application. The welded assembly usually comes off the welding machine as a cylinder. This cylinder is then passed through rollers and flattened out. As it leaves the flattening rollers it is cut into the desired size and the flat bar is welded onto the support rods keeping the panel flat. The panel is then inserted into a mould for the polyurethane peripheral frame to be poured to incorporate the panel fixing system.

The arrangement of this invention has the advantage that the life of the panels is extended and the wire profiles of this invention provide a greater open area than that provided by polyurethane panels. In a trial in a screening plant the screening surface of this invention had worn 60% less than a hard Chromed equivalent panel over a period of 7 weeks.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A mining screening panel comprising a screening surface comprising spaced stainless steel profiled wires supported on transversely extending spaced rods or bars in which the cross sectional shape of the profiled wires is a vertical, truncated diamond.

2. The screening panel as claimed in claim 1, wherein a bottom angle of the diamond is rounded or flattened.

3. The screening panel as claimed in claim 1, wherein the screening surface is surrounded by a peripheral polyurethane frame that incorporates a panel fixing system.

4. The screening panel as claimed in claim 1, wherein a widest portion of the vertical diamond constitutes a notional screening surface and a distance between the wires at this position defines the size of the screening aperture.

5. The screening panel as claimed in claim 3, wherein a top portion is an inverted wedge with a flat top with depending diverging sides and a bottom portion is a wedge with dependent converging sides with a flat or convex bottom.
